(19) United States
(12) Patent Application Publication
(10) Pub. No.: US 2009/0190304 A1
(43) Pub. Date: Jul. 30, 2009

(54) COOLING DEVICE FOR MEMORY MODULE

(76) Inventors: George Anthony Meyer, IV, San Jose, CA (US); Chien-Hung Sun, Zhongli City (TW); I-Ying Lee, Zhongli City (TW)

Correspondence Address: HDLS Patent & Trademark Services, P.O. BOX 220746, CHANTILLY, VA, 20153-0746, US

(21) Appl. No.: 12/170,598

(22) Filed: Jul. 10, 2008

(30) Foreign Application Priority Data
Jan. 29, 2008 (TW) 097201944

(51) Int. Cl. G06F 1/20

(52) U.S. Cl. 361/679.47

(57) ABSTRACT

A cooling device for memory module is held onto a memory module and includes a first cooling assembly, a second cooling assembly, and a fastener. In the invention, the first cooling assembly includes a cooling plate and a vapor chamber, in which cooling fins are formed at one side of the cooling plate, at upper side of which engaging parts are formed. One inner side of the cooling plate is attached to one side of the vapor chamber, while another side is attached to the memory module. The second cooling assembly also includes a cooling plate and a vapor chamber. Cooling fins are formed at one side of the cooling plate, at upper side of which engaging parts are formed. When the two cooling plates are fixed correspondingly, all cooling fins are aligned correspondingly, and the engaging parts are engaged to each other. In the meantime, at least one fastener is applied for clamping and fixing the first and second cooling assemblies together. Thereby, two sides of the memory module are provided with vapor chambers capable of rapid heat conduction to boost the cooling efficiency of the entire cooling device.

### BACKGROUND OF THE INVENTION

1. Field of the Invention

The present invention generally relates to a cooling device, in particular, to a cooling device for memory module.

2. Description of Prior Art

Since the emergence of information era, computer has become an indispensable device for everyone of us. Currently, the relative industries are doing all their best to upgrade the auxiliary products for any computer device. For example, the capacity of Random-Access Memory (RAM) has grown to 128*4 GB from 64 KB, while a further larger capacity of RAM will be developed in the future. In the past, there is no need to install any cooling device, because the power is small when an RAM is operating. But, following the increasing capacity of RAM, a cooling device capable of effectively reducing the relatively high temperature is needed.

Therefore, as shown in FIG. 1, a cooling device for RAM has been designed out. According to this prior art, the cooling device 100a includes two cooling plates 2a and a plurality of fasteners 3a, in which two cooling plates 2a are attached to the surfaces of the memory module, then the two cooling plates 2a are hold and secured by the plural fasteners 3a to tightly sandwich the memory module between the two cooling plates 2a. When the memory module operates, the two cooling plates 2a can dissipate the high heat generated by the memory module.

However, although the heat generated by the memory module can be dissipated by the cooling device 100a according to the prior art, the cooling efficiency is still poor because only two cooling plates 2a are used. Therefore, how to further promote the cooling efficiency done to the entire memory module by the cooling device is thus become a tough issue needed to be solved by the relative industries urgently.

Accordingly, aiming to solving the aforementioned shortcomings, after a substantially devoted study, in cooperation with the application of relatively academic principles, the inventor has at last proposed the present invention “Cooling Device for Memory Module” that is designed reasonably to possess the capability to improve the prior arts significantly.

### SUMMARY OF THE INVENTION

The invention is mainly to provide a cooling device for memory module, which is for being hold and secured to corresponding surfaces of a memory module. The cooling device includes a first cooling assembly, a second cooling assembly, and at least one fastener. In the invention, the first cooling assembly includes a cooling plate and a vapor chamber, in which at least one set of cooling fins are formed at one side of the cooling plate; in addition, at least one engaging part is arranged at an upper side of the cooling plate. During assembly, one side of the vapor chamber is attached to an inner side of the cooling plate, while another side is attached to the memory module. Same as the first cooling assembly, the second cooling assembly includes a cooling plate, at one side of which at least one set of cooling fins are formed to be aligned to the cooling fins of the first cooling assembly. Again, at least one engaging part is arranged at an upper side of the cooling plate to be engaged to the engaging part of the first cooling assembly. Finally, at least one fastener is applied to hold the first cooling assembly and the second cooling assembly together and securely.

Secondly, the invention is to provide a cooling device for memory module, which is for being hold and secured to corresponding surfaces of a memory module. The cooling device includes two cooling assemblies and at least one fastener, in which the cooling assembly includes a cooling plate and a vapor chamber. At least one set of cooling fins is formed at one side of the cooling plate, at upper side of which at least one engaging part is arranged. One side of the vapor chamber is attached to an inner side of the cooling plate, while another side is attached to the memory module. In the invention, the fastener is for holding the two cooling assemblies together and securely. When the fastener is holding the two cooling assemblies, the two engaging parts are engaged to each other, and the two sets of cooling fins are aligned to each other as well.

From the structure described above, we know that two sides of the memory module are all attached with vapor chambers capable of rapid heat conduction, boosting the cooling efficiency done to the memory module by the cooling device according to the invention.

In addition, since at least one set of cooling fins is respectively arranged at an upper side of the two cooling plates, the cooling fins can further effectively dissipate the working heat generated from the memory module by aligning the cooling fins of the two cooling plates, when the cooling plates are held together.

### BRIEF DESCRIPTION OF DRAWING

The features of the invention believed to be novel are set forth with particularity in the appended claims. The invention itself, however, may be best understood by reference to the following detailed description of the invention, which describes an exemplary embodiment of the invention, taken in conjunction with the accompanying drawings, in which:

FIG. 1 is an explosively perspective view of a cooling device according to the prior art;

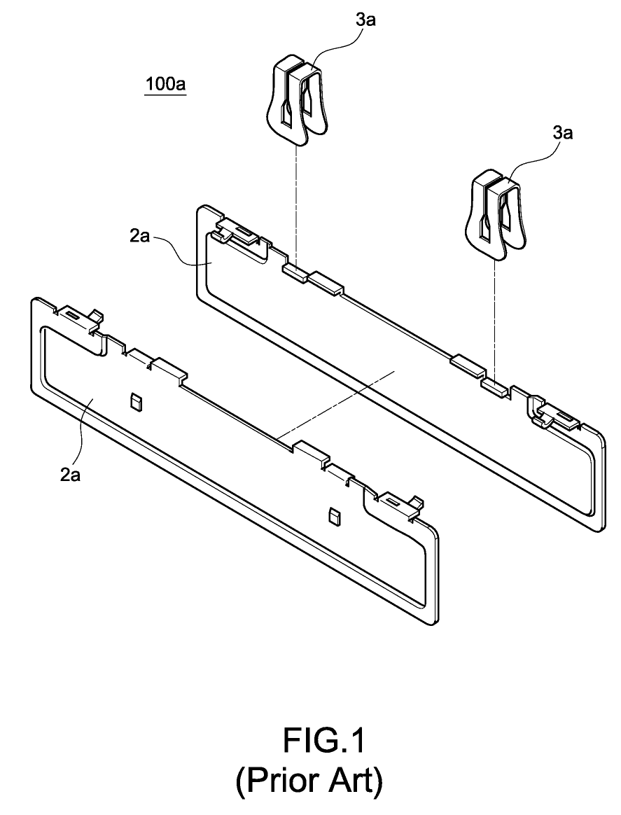

FIG. 2 is an explosively perspective view of a cooling device according to the present invention;

FIG. 3 is a perspective view of the invention when two cooling assemblies are not clamped onto the memory module;

FIG. 4 is a perspective view of a cooling device according to the present invention; and

FIG. 5 is a sectional view based upon the sectional line “5-5” in FIG. 4.

### DETAILED DESCRIPTION OF THE INVENTION

In cooperation with attached drawings, the technical contents and detailed description of the invention are described thereinafter according to a preferable embodiment, being not used to limit its executing scope. Any equivalent variation and modification made according to appended claims is all covered by the claims claimed by the present invention.

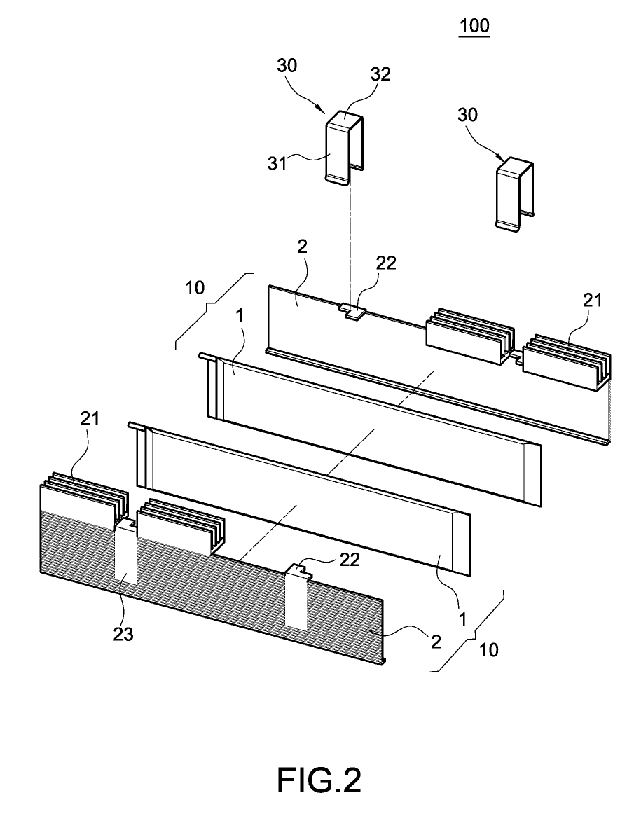

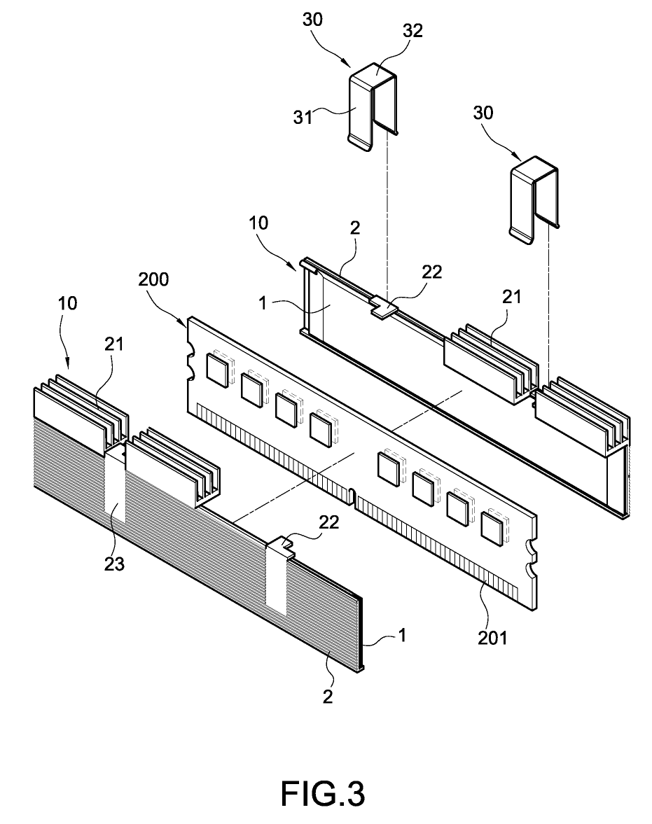

The invention is a cooling device for memory module. As shown in FIG. 2 and FIG. 3, the invention basically is a cooling device 100 comprised of two cooling assemblies 10 structured identically and capable of being securely hold to two side surfaces of a memory module 200, and two fasteners 30. In addition, the number of the fastener 30 can just be one.

According to a preferable embodiment of the invention, the two cooling assemblies 10 respectively have a vapor chamber 1, which is shown as stripe shape, and the length of which is substantially same as that of the memory module 200. In this case, there are working fluid and capillary tissues arranged in the vapor chamber 1, in which a vapor-liquid phase change of the working fluid may become a heat transferring mechanism. On one side surface of the vapor chamber 1, a cooling plate 2 is attached and shown as a stripe shape, the length of which is substantially same as that of the vapor chamber 1, and which is made of one of aluminum, copper, aluminum alloy or copper alloy materials capable of excellent heat transfer, and at one side edge of which at least one set of cooling fins 21 is formed. In this case, there are two sets of cooling fins 21 that are spaced in a specific distance in one cooling plate 2. The cooling fins 21 of the two cooling plates 2 are aligned, when the two cooling plates 2 are hold together and securely.

In addition, an engaging part 22 is arranged at an appropriate position at an upper side edge of the cooling plate. In this case, two engaging parts 22 each shown as “L” shape are respectively arranged at two sides of the cooling plate 2. When the two cooling plates 2 are hold face to face, the “L”-shaped engaging parts 22 on the two cooling plates 2 are engaged to each other and shown as a square configuration.

Please refer to FIG. 2 continuously, a vertical path of recessing part 23 is arranged on an outer side surface of the cooling plate 2 corresponding to each engaging part 22. A fastener 30 shown as a reversed “U” shape clamps the cooling plates 2 at the recessing parts 23 which is made of steel and having good elastic-clamped force. The fastener 30 is comprised of two elastic clipping pieces 31 corresponded to each other, and a connecting piece 32 connecting the two clipping pieces 31. During assembly, two recessing parts 23 correspondingly arranged at two cooling plate 2 are hold by these two elastic clipping pieces 31.

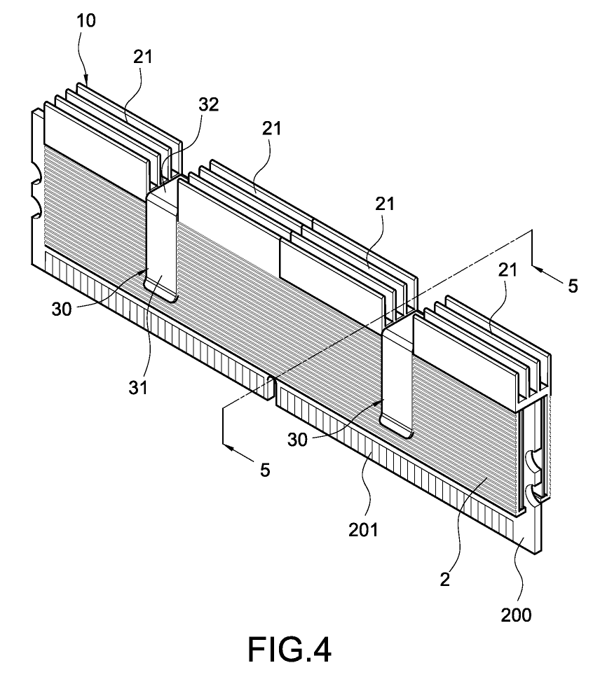

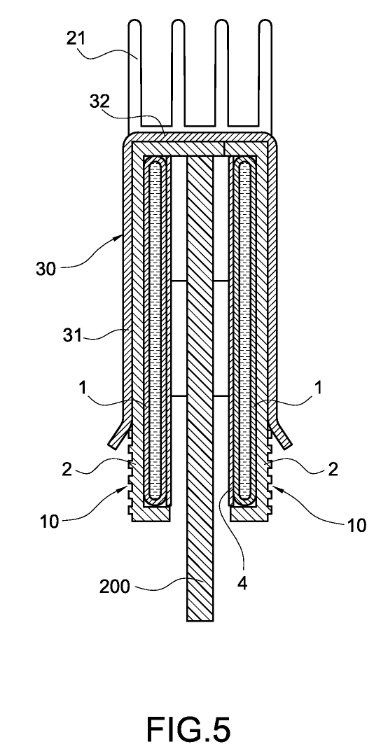

Please refer to FIG. 2, FIG. 3, and FIG. 4. When a memory module 200 is arranged a cooling device according to the present invention, two vapor chambers 1 have already arranged on the two cooling plates 2 respectively. Two cooling plates 2, both of which have a vapor chamber 1 on each inner side surface, are respectively attached onto two side surfaces of the memory module 200. During holding process, a heat-conducting media 4 (as shown in FIG. 5) can be coated on a side surface of the vapor chamber 1 to be attached to the memory module 200. The working heat generated from the memory module 200 can be rapidly transferred to the vapor chamber 1 via this kind of heat-conducting media 4. When the two cooling plates 2 is holding the memory module 200, the “L”-shaped engaging parts 22 on each cooling plate 2 are engaged to each other, making the memory module 200 enclosed therein except the gold finger joints 201. Finally, the recessing parts 23 on the two cooling plates 2 are clamped by the fasteners 30 to complete a process of assembling a cooling device 100 to a memory module 200.

From aforementioned structure, we know that, since two vapor chambers 1 capable of rapid heat transfer are respectively arranged at two outer side surfaces of the memory module 200, the cooling efficiency done to the memory module 200 by the cooling device 100 is thereby boosted. In addition, the working heat generated from the memory module 200 can be further effectively dissipated by the cooling fins 21 arranged at the cooling plate 2.

Summarizing aforementioned description, the invention is a novel structure of a cooling device for memory module indeed, which may positively reach the expected usage objective for solving the drawbacks of the prior arts, and which extremely possesses the innovation and progressiveness to completely fulfill the applying merits of new type patent, according to which the invention is thereby applied. Please examine the application carefully and grant it as a formal patent for protecting the rights of the inventor.

Moreover, the aforementioned description is only a preferable embodiment according to the present invention, being not used to limit the patent scope of the invention, so equivalently structural variation made to the contents of the present invention, for example, description and drawings, is all covered by the claims claimed thereinafter.

What is claimed is:

1. A cooling device for memory module, which is for being hold and secured to corresponding surfaces of a memory module, including:
a first cooling assembly, which includes a first cooling plate and a vapor chamber, in which at least one set of first cooling fins is formed at one side of the first cooling plate, in addition, at least one first engaging part being arranged at an upper side of the first cooling plate, one side of the vapor chamber being attached to an inner side of the first cooling plate, while another side being attached to the memory module;
a second assembly, which includes a second cooling plate, in which at least one set of second cooling fins is formed at one side of the second cooling plate and aligned to the first cooling fins, in addition, at least one second engaging part being arranged at an upper side of the second cooling plate and to be engaged to the first engaging part; and
at least one fastener, which is applied to hold the first cooling assembly and the second cooling assembly together and securely.

2. The cooling device for memory module according to claim 1, wherein the first and second cooling plates are made of aluminum material.

3. The cooling device for memory module according to claim 1, wherein the first and second engaging parts are respectively shown as an “L” shape.

4. The cooling device for memory module according to claim 3, wherein at least one recessing part is arranged on an outer surface of the cooling plate and corresponding to the engaging part, and wherein the fastener shown as a reversed “U” shape includes two elastic clipping pieces corresponding to each other and a connecting piece connecting the two clipping pieces, and the recessing parts of the two cooling plates are clipped by the two clipping pieces.

5. The cooling device for memory module according to claim 1, wherein a heat-conducting media is coated on a surface of the vapor chamber to be contacted with the memory module.

6. A cooling device for memory module, which is for being hold and secured to corresponding surfaces of a memory module, including:
two cooling assemblies, each of which includes a cooling plate and a vapor chamber, in which at least one set of cooling fins is formed at one side of the cooling plate, at upper side of which at least one engaging part is arranged, in addition, one side of the vapor chamber being attached to an inner side of the cooling plate, while another side being attached to the memory module; and
at least one fastener, which is for holding the two cooling assemblies together and securely;
characterized in that, when the fastener is holding the two cooling assemblies, the two engaging parts are engaged to each other, and the two sets of cooling fins are aligned to each other as well.

7. The cooling device for memory module according to claim 6, wherein the cooling plate is made of aluminum material.

8. The cooling device for memory module according to claim 6, wherein the engaging part is shown as an “L” shape.

9. The cooling device for memory module according to claim 8, wherein at least one recessing part is arranged on an outer surface of the cooling plate and corresponding to the engaging part, and wherein the fastener shown as a reversed “U” shape includes two elastic clipping pieces corresponding to each other and a connecting piece connecting the two clipping pieces, and the recessing parts of the two cooling plates are clipped by the two clipping pieces.

10. The cooling device for memory module according to claim 6, wherein a heat-conducting media is coated on a surface of the vapor chamber to be contacted with the memory module.
